(19) United States
(12) Patent Application Publication
(10) Pub. No.: US 2009/0046089 A1
(43) Pub. Date: Feb. 19, 2009

(54) BURN-IN COMPENSATION FOR DISPLAY

(75) Inventors: Zhiming Zhuang, Kildeer, IL (US); Ken K. Foo, Gurnee, IL (US); John W. Kaehler, Lake Bluff, IL (US); Robert D. Polak, Lindenhurst, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/839,811

(22) Filed: Aug. 16, 2007

(51) Int. Cl. G06F 3/038

(52) U.S. Cl. 345/214

(57) ABSTRACT

In accordance with one embodiment, apparatus are provided, which include a burn-in compensation pixel generator and burn-in compensation circuitry. The burn-in compensation pixel generator is configured to generate burn-in compensation pixel data. The burn-in compensation circuitry is configured to provide, within break-from-standard-use periods of a device employing a display, the generated burn-in compensation pixel data instead of a select predetermined subset of default pixel data, for input to a display interface of the display.

### COPYRIGHT NOTICE

This patent document contains information subject to copyright protection. The copyright owner has no objection to the facsimile reproduction by anyone of the patent document or the patent, as it appears in the US Patent and Trademark Office files or records, but otherwise reserves all copyright rights whatsoever.

### FIELD OF THE DISCLOSURE

The present disclosure, in certain aspects, is related to displays provided in electronic devices, for example, embedded devices such as mobile phones. Other aspects of the disclosure relate to compensating for burn-in effects to such displays.

### BACKGROUND

Electronic device displays frequently encounter burn-in effects. This is caused when certain images on the display have significant luminance, for prolonged periods of time. Various approaches have been employed to compensate for the burn-in effect in displays. For example, United States Published Patent Application No. 2005/0062680 discloses a method and apparatus for compensating for a difference in picture quality caused by burn-effects on a display screen. U.S. Published Patent Application No. 2005/0093850 discloses an organic electro-luminescence display, which changes the luminance of different areas of a display to prevent burn-in.

### SUMMARY

Apparatus may be provided, comprising a burn-in compensation pixel generator and burn-in compensation circuitry. The burn-in compensation pixel generator is configured to generate burn-in compensation pixel data. The burn-in compensation circuitry is configured to provide, within break-from-standard-use periods of a device employing a display, burn-in compensation pixel data instead of a select predetermined subset of default pixel data, for input to a display interface of the display.

### BRIEF DESCRIPTION OF THE DRAWINGS

Embodiments of the disclosure are further described in the detailed description which follows, by reference to the noted drawings, in which like reference numerals represents similar parts throughout the several views of the drawings, and wherein:

FIG. 1 is a block diagram of an electronic device in accordance with one embodiment of the present disclosure; and

FIG. 2 is a flowchart of an embodiment of a process for determining the replacement pixels.

### DETAILED DESCRIPTION

Various features and advantages of example embodiments are set forth in the description which follows. While specific embodiments and implementations are discussed, it should be understood that these specifics are for illustration purposes only. It should be recognized that other components and configurations may be used without departing from the spirit and scope as set forth, for example, in the claims.

Embodiments described herein may include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disc storage, magnetic disk storage or other magnetic storage devices, or any other medium which can be used to carry or store desired program code or other data, including data structures, in the form of computer-executable instructions or data representations, or data structures. When information is transferred or provided over a network or another communications collection (either hard wired, wireless, or a combination thereof) to a computer, the computer properly views the connection as a computer-readable medium. Thus, any such connection is properly termed a computer-readable medium. Combinations of the above should also be included within the scope of computer-readable media or medium.

Computer-executable instructions include, for example, instructions and data which cause a general purpose computer, a special purpose computer, or a special purpose processing device to perform a certain function or group of functions. Computer-executable instructions also include program modules or other portions that are executed by computers in stand alone or network environments. Processing can be on one platform or distributed among plural platforms. Generally, program modules include routines, programs, objects, components, data structures, and so on, that perform tasks or implement abstract data types. Computer-executable instructions, data structures associated with such instructions, and program modules are examples of program code for executing steps or acts as disclosed herein. A particular sequence of executable instructions or associated data content, including data structures, represents examples of corresponding acts for implementing the functions described in such steps.

In certain embodiments of the present disclosure, apparatus, a method, or an electronic device (for example, a hand-held device) may be provided. The present disclosure may also be directed to one or more portions of such apparatus, method, or electronic device, or a plural set of more than one such apparatus, method, or electronic device.

In accordance with one embodiment, apparatus are provided including burn-in compensation circuitry configured to provide, within break-from-standard-use periods of a device employing a display, burn-in compensation pixel data instead of a select predetermined subset of default pixel data, for input to a display interface of the display. Pixel data includes color and intensity information corresponding to cells or regions on the display, where such cells or regions may be referred to as “pixels.” The subset of default pixel data, during standard use periods, cause at least part of an image to be displayed, which may result in burn-in. The default pixel data during break-for-standard-use periods (e.g., a standby or recharging mode), may cause a black, neutral, reduced luminance, or some altered image at the corresponding pixels on the display, if the burn-in compensation circuitry did not provide burn-in compensation pixel data to the display interface.

The apparatus may further include a display, which in the embodiment illustrated herein includes an organic light-emitting diode (OLED) type of display. In addition, a display interface and display circuitry may each be provided, and the burn-in compensation circuitry may be provided as part of the display circuitry. The apparatus may be an electronic device, or it may be a hand-held device. In one example embodiment, the electronic device is a mobile phone.

The replacement pixel data, which are referred to as burn-in compensation pixel data, may include pixel data which result in an inversion of the relevant portions of the mostly used image (a select predetermined subset of default pixels in the standard use period) to smooth out the burn-in effect in the surrounding area of the image. For example, inversion may be as follows [R′, G′, B′]=[Rmax-R, Gmax-G, Bmax-B], where Rmax, Gmax, and Bmax are maximum settings for the RGB color [e.g., 256 for 8 bit], and RGB are the three primary color settings of an image, such as a fixed soft key, that causes burn-in. The replacement pixel data may also be chosen so that the effective burn-in in the compensated area results in an even burn-in. The replacement pixel data may be chosen so as to replace and thereby increase the luminance in the areas abutting or near the image likely to be burned-in. Replacement pixel data may also be chosen so as to cause a decrease in the luminance in likely burn-in image areas. In addition, or in the alternative, the burn-in images' pixel data may be shifted around in order to cause a minimization of the burn-in effects associated with such images.

The predetermined subset of default pixel data to be replaced may be pixel data in a soft key area of a display screen of a hand-held device, e.g., a mobile phone.

In another embodiment, the subset of default pixel data include pixel data corresponding to fixed user interface features of the display. The fixed user interface features may be in a main area of the display and/or in a soft key area (or areas) of the display. The soft key area or areas may be, for example, in the periphery of the display or in another portion of the display that will not interfere with the main (generally more frequently changing) viewing area of the display.

The main (generally more frequently changing) area of the display may be an area of the display of the device that is used, for example, to display images, video, 3D graphics associated with a game, or other images or text pertaining to any functionality of the device.

Fixed user interface features may, for example, include icons that are kept on the display, and/or soft keys. For example, one or more portions of the display may be reserved to cause a constant display of certain soft keys.

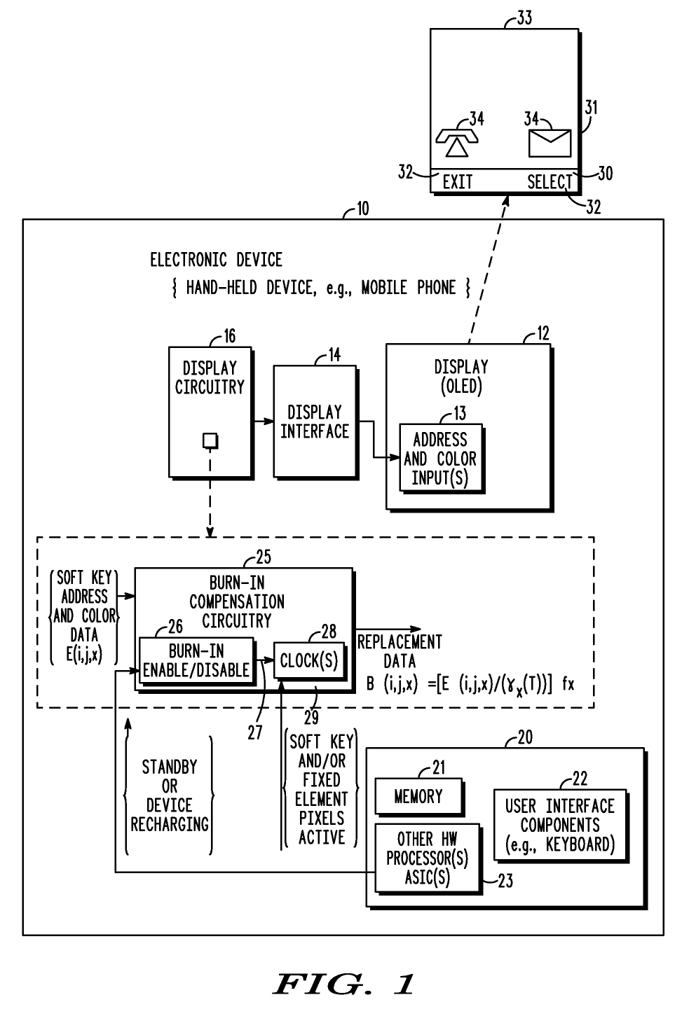

FIG. 1 is a block diagram of one embodiment of an electronic device 10. The illustrated electronic device 10 includes a display 12, a display interface 14, and display circuitry 16. Electronic device 10, in this embodiment, is a hand-held device (for example, a mobile phone). The illustrated electronic device 10 includes other elements 20. Other elements 20 include, in this embodiment, memory 21, user interface components 22, and other hardware 23, for example, one or more processors and one or more application specific integrated circuits (ASICs). Alternatively, all the elements forming electronic device 10 may be provided on a system on a chip. The illustrated display circuitry 16 includes burn-in compensation circuitry 25. The illustrated burn-in compensation circuitry 25 includes a burn-in enable/disable mechanism 26 and one or more clocks 28.

Burn-in enable/disable mechanism 26 enables or disables the burn-in process performed by burn-in compensation circuitry 25 so that burn-in compensation circuitry 25 will replace the select predetermined subset of default pixel data on the display at periods of time within “break-from-standard-use” periods of the illustrated device. In the embodiment illustrated in FIG. 1, accordingly, burn-in enable/disable mechanism 26 receives a signal notifying it that electronic device 10 is in such a break-from-standard-use period. In this embodiment, this period is when the device is in a standby mode and/or when the device is recharging.

One or more clocks 28 is/are provided to determine (1) a tally of the amount of time during which certain pixels are illuminated in accordance with their default illumination (illumination causing burn-in) and (2) a tally of the amount of time of the burn-in compensation periods when replacement pixel data are employed. Accordingly, the one or more clocks 28 includes/include one input (or set of inputs) 27 to be notified when the burn-in compensation has been enabled and disabled (for determining when burn-in compensation is occurring) and another input (or set of inputs) 29 for receiving an indication of when the subset of pixels corresponding to the subset of default pixel data to be compensated (in this embodiment one or both of the soft key and/or other fixed element pixels) are active (i.e., illuminated).

The illustrated display 12, in the example embodiment, includes an OLED type of display. The illustrated display 12 includes an input or inputs 13 for receiving address and color information, specifically, pixel data, which will be displayed at respective pixel positions within display 12. The address and color input(s) 13 receive(s) such pixel information from display interface 14. Display circuitry 16 provides pixel information to display interface 14. In one embodiment of the device, display interface 14 includes, among other elements, a serial to parallel data converter, for converting serial pixel data to parallel form, more readily received by display 12. Display circuitry 16 includes, among other elements (not specifically shown), burn-in compensation circuitry 25.

Display 12, in certain types of devices, particularly a mobile phone which is one example of the embodiment shown, presents to users a display screen 31 including a main area 33 and a soft key area 30. One or more soft key images 32 are displayed within soft key area 30. Soft key area 30 includes soft key images 32 presented on the display by illuminating certain soft key pixels. The illustrated display screen 31 may also include one or more fixed user interface features 34. In this example, the fix user interface features 34 include a telephone icon and an email icon.

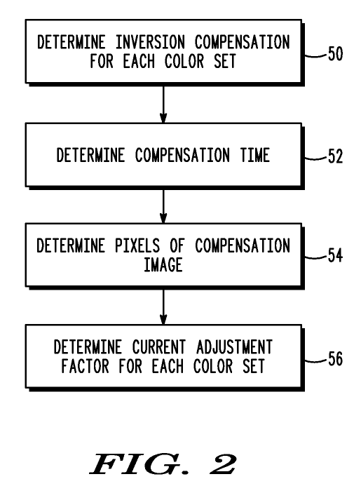

FIG. 2 is a flow chart of an example process that can be performed in determining the pixel values that are to form the replacement pixels. In a first act 50, the inversion compensation for each color set is determined.

The inversion compensation for each color set (R, G, and B) may determined as follows:

The burn-in for a given color pixel for a given use period (t) can be summarized as:

$${E}_{ij , x} = {\int }_{{t}_{o}}^{{t}_{c}} ( {γ}_{x} {B}_{ij , x} ( t ) t ) ;$$

where B_{ij,x}(t) is the brightness setting of the pixel (i,j) for color x (R, G or B) at time t; γₓ is the gamma curve for the OLED for color x; to is the time of the last compensation operation; and t_{c} is the time of the current compensation operation.

If B is in the range of (0, 255), then the inversion compensation for each color set can be characterized as:

E_{ij,x}=max(E_{ij,x})−E_{ij,x}

In a next act 52, the compensation time is determined. To minimize the compensation period time, each the color pixels that need the most compensation may be set at its most efficiency brightness setting Bₓ, so that the whole compensation can be carried out in

T=max(E_{ij,x})/(Bₓγₓ)

In a next act 54, a determination is made of each of the pixels forming the compensation image. The compensation image can be calculated as

B_{ij,x}=E_{ij,x}/(γₓT)

Since each color in an OLED will generally decay at a different slope of αₓ, x=R, G, or B, in act 56, the current Ix can be adjusted/scaled for each color after the inversion compensation with the factor: fx=Io*(αx/max(αx)). The current scale factor fₓ is multiplied by the intensity values for each color component in the compensation image.

The claims, as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees, and others.

1. Apparatus comprising:
a burn-in compensation pixel generator configured to generate burn-in compensation pixel data; and
burn-in compensation circuitry configured to provide, within break-from-standard-use periods of a device employing a display, the generated burn-in compensation pixel data instead of a select predetermined subset of default pixel data, for input to a display interface of the display.

2. The apparatus according to claim 1, further comprising the display.

3. The apparatus according to claim 2, wherein the display includes an organic light-emitting diode (OLED) display.

4. The apparatus according to claim 1, further comprising the display interface configured to receive signals to be displayed on the display, and further comprising display circuitry, the display circuitry including the burn-in compensation circuitry.

5. The apparatus according to claim 1, wherein the burn-in compensation pixel data is an inversion of mostly used data of corresponding pixels during the standard use period.

6. The apparatus according to claim 1, wherein the select predetermined subset of default pixel data are replaced with pixel data causing an even burn-in for the images associated with the subset of default pixels during the standard use period.

7. The apparatus according to claim 1, wherein the select predetermined subset of default pixel data are replaced with pixel data causing an increase in luminance in an area abutting or near an image likely to be burned-in.

8. The apparatus according to claim 1, wherein the select predetermined subset of default pixel data are replaced so as to cause a shift of image pixels from ones in the standard use period so as to minimize a burn-in effect.

9. The apparatus according to claim 1, wherein the select predetermined subset of default pixel data correspond to pixels in a soft key area of the display.

10. The apparatus according to claim 1, wherein the select predetermined subset of default pixel data correspond to pixels corresponding to fixed user interface features of the display.

11. A method comprising:
generating burn-in compensation pixel data; and
providing, within break-from-standard-use periods of a device employing a display, the generated burn-in compensation pixel data instead of a select predetermined subset of default pixel data, for input to a display interface of the display.

12. The method according to claim 11, further comprising providing the display.

13. The method according to claim 12, wherein the display includes an organic light-emitting diode (OLED) display.

14. The method according to claim 11, wherein the inversion compensation for each color set (R, G, and B) is determined by performing the following acts:
characterizing the inversion compensation for each color set as:
E_{ij,x}=max(E_{ij,x})−E_{ij,x}
where the burn-in for a given color pixel for a given use period (t) can be summarized as:
$${E}_{ij , x} = {\int }_{{t}_{o}}^{{t}_{c}} ( {γ}_{x} {B}_{ij , x} ( t ) t ) ,$$
where B_{ij,x}(t) is the brightness setting of the pixel (i,j) for color x (R, G or B) at time t; γₓ is the gamma curve for the OLED for color x; to is the time of the last compensation operation; and t_{c} is the time of the current compensation operation;
setting each of the color pixels needing compensation at an efficient brightness setting Bₓ, so the compensation can be carried out in
T=max(E_{ij,x})/(Bₓγₓ); and
determining each of the pixels forming the compensation image in accordance with
B_{ij,x}=E_{ij,x}/(γₓT).

15. An electronic device comprising:
a burn-in compensation pixel generator configured to generate burn-in compensation pixel data; and
burn-in compensation circuitry configured to provide, within break-from-standard-use periods of a device employing a display, the generated burn-in compensation pixel data instead of a select predetermined subset of default pixel data, for input to a display interface of the display.

16. The electronic device according to claim 15, further comprising the display.

17. The electronic device according to claim 16, wherein the display includes an organic light-emitting diode (OLED) display.

18. The electronic device according to claim 15, further comprising the display interface configured to receive signals to be displayed on the display, and further comprising display circuitry, the display circuitry including the burn-in compensation circuitry.

19. The electronic device according to claim 15, wherein the burn-in compensation pixel data is an inversion of mostly used data of corresponding pixels during the standard use period.
